(19) United States
(12) Patent Application Publication
(10) Pub. No.: US 2006/0128398 A1
(43) Pub. Date: Jun. 15, 2006

(54) Network support for image blocking based on location stamp

(76) Inventors: Frances Mu-Fen Chin, Naperville, IL (US); Peggy Hasan, Aurora, IL (US); Sandra Lynn True, St. Charles, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/013,978

(22) Filed: Dec. 15, 2004

(51) Int. Cl. H04M 3/00; H04Q 7/20

(52) U.S. Cl. 455/456.3; 455/419

(57) ABSTRACT

A wireless telecommunication network recognizes and blocks image transmissions from designated “no image zones.” In such manner, the wireless telecommunication network can block the transmission of video and/or photo images from mobile image device(s) (e.g., picture phones) attempting to send images from sensitive locations.

### CROSS-REFERENCE TO RELATED APPLICATIONS

This invention is related to U.S. patent application Ser. No. ______, titled “Network Support for Corrupting Images Captured at a Prohibited Location,” filed concurrently with the present application.

### FIELD OF THE INVENTION

This invention relates generally to wireless telecommunication systems that support image messaging from mobile devices and, more particularly, to a method for restricting transmission of images captured within certain “no image” zones.

### BACKGROUND OF THE INVENTION

Communication systems are well known in which mobile devices (e.g., wireless phones) may send and receive messages with other mobile devices or network devices via a wireless telecommunication infrastructure. Depending on the capability of the mobile device, the messages may comprise image information as well as voice or text information. For example, so called “picture phones” including built-in cameras enable a user to take a still photo image, or “picture” of a subject and send it to another mobile device or an e-mail recipient via a telecommunication network. Optionally, the image information may be combined with other data such as text or audio. Further, next-generation phones are coming soon that will have the ability to capture and send streaming video information with other data. For convenience, the term “mobile image device” will be used hereinafter to refer to a mobile device having image processing capability, including but not limited to still photos or streaming video images.

While mobile image devices represent an important technological advance, they raise some problems on the social level. For instance, there is a valid concern that mobile image devices may compromise individuals (or groups) expectations of privacy in certain sensitive areas, such as locker rooms or rooms in which sensitive information of an individual or organization resides. In effect, there is nothing to stop unscrupulous individuals from taking photos or videos at such locations and sending them via the telecommunication network to the Internet, for example, or to virtually any device connected to the telecommunication network. Such images can be captured with relative ease since mobile image devices are relatively small and many can be set to make the shutter click silently, often without detection. Adding insult to injury, the laws generally do not provide adequate penalties to deter the offending party in the event they are discovered.

Accordingly, there is a need to protect individuals or groups expectation of privacy in certain sensitive areas by restricting the transmission of images captured from mobile image devices in those areas.

### SUMMARY OF THE INVENTION

This need is addressed and a technical advance is achieved in the art by a feature whereby a wireless telecommunication network is adapted to recognize and block image transmissions from designated “no image zones.” In such manner, the wireless telecommunication network can block the transmission of video and/or photo images from mobile image device(s) attempting to send images from the “no image zone.”

In one embodiment, a mobile switching center (MSC) of a telecommunication network receives an image message sourced from a mobile image device. The MSC determines a source location associated with the image message and consults a database to determine whether the source location coincides with a designated no-image zone. The MSC blocks further transmission of the image message if the source location is determined to coincide with a designated no-image zone.

In another embodiment, an MSC receives an image message sourced from a mobile image device, the image message including a location-stamp having indicia of its source location. The MSC determines whether the source location coincides with a designated no-image zone and blocks further transmission of the image message if the source location is determined to coincide with a designated no-image zone. The MSC permits further transmission of the image message if the source location is determined to not coincide with a designated no-image zone.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented; and

FIG. 2 is a flowchart of a method that provides for recognizing and blocking image transmissions from mobile image devices located in designated “no image zones.”

### DESCRIPTION OF THE PREFERRED EMBODIMENT(S)

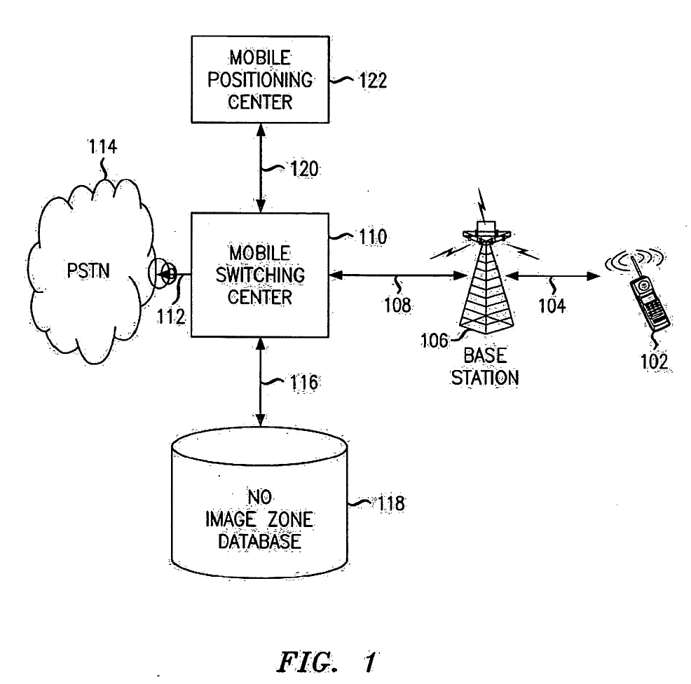

FIG. 1 shows a communication system 100 according to an exemplary embodiment of the invention that is operable to recognize and selectively block image transmissions from designated “no image zones.” A mobile image device 102 is nominally operable to capture and send image information including, but not limited to, still photo images or streaming video information associated with a subject (not shown). The image information may be combined with other data such as text or audio.

The mobile image device 102 is connected by wireless link 104 to a base station 106. The wireless link 104 may implement air interface technologies including but not limited to, CDMA, TDMA, GSM, UMTS or IEEE 802.11. The base station 106 is connected by link 108 to a switching element 110 (as shown, a mobile switching center (MSC). The MSC 110 may comprise, for example, an AUTOPLEX™ switching system, available from Lucent Technologies, Inc. The MSC 110 includes a memory and processor (not shown), for storing and executing software routines for processing and switching calls and for providing various call features to calling or called parties. The MSC 110 may be configured for operation with generally any suitable circuit, cell, or packet switching technology. As will be appreciated, the MSC 110 is a functional element that may reside in a single device or may be distributed among multiple devices and/or locations.

The MSC 110 is connected by link 112 to a network 114 (as shown, the Public Switched Telephone Network (PSTN)). The network 1 14 may be implemented using any appropriate transmission, switching and routing technologies, including but not limited to Internet Protocol (IP) and Asynchronous Transfer Mode (ATM) technologies. As will be appreciated, the network may comprise or may be interconnected with a number of different types of networks including local area networks (LANs), wide area networks (WANs), metropolitan area networks (MANs), the Internet, virtual private networks (VPNs) and/or corporate intranets. In such manner, the MSC 110 may send and receive images and other messages to endless numbers of computers and/or telephony devices residing without limitation, within business enterprises, government and scientific groups, educational and research institutions or private residences.

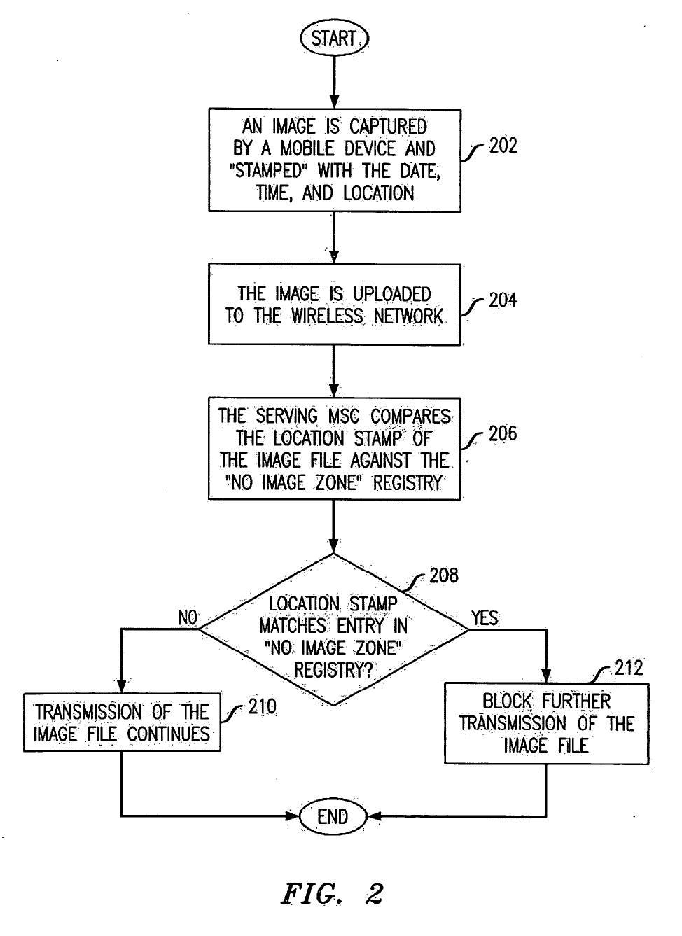

In the exemplary embodiment of FIG. 1, it is presumed that the mobile image device 102 has captured image information comprising one or more photos or streaming video associated with a subject and is attempting to send the image information to a called party. The called party (not shown) may comprise another mobile image device or virtually any computer or telephony device operably connected to the MSC 110 or network 114. In one embodiment as will be described in greater detail in relation to FIG. 2, the MSC 110 is adapted to receive the image information and determine, based on the location of the sending device, whether to block transmission of the image data to the called party device. In one embodiment, the MSC 110 will block the image data if the sending mobile image device 102 is located within a designated “no image zone.”

In one embodiment, the MSC consults a “no image zone” database 118 to help determine if the sending device is located within a “no image zone” and hence should have its image data blocked. The MSC is connected to the database 118 by link 116. Link 116 is a logical link that may be physically realized, without limitation, by conventional subscriber lines, Asynchronous Transfer Mode (ATM) lines, ISDN lines, Ethernet LAN or WAN, wireless links, and the like. The “no image zone” database 118 includes location information associated with various designated “no image zones.”

The location information may comprise, for example and without limitation, geo-location information such as latitude, longitude and elevation of various “no image zones.” The location information may indicate, for example, a center point location of various “no image zones.” In one embodiment, the MSC derives boundary information from the center point location. For example, the MSC might consider a particular “no image zone” to extend a threshold radius amount (e.g., 100 feet) from a center point location. Alternatively, the location information itself may include boundary information. For example, the location information might specify a plurality of “corner” points specified by latitude, longitude and elevation; and the MSC extrapolates the corner point locations to derive a geographical boundary of the no-image zones.

The manner of determining which location areas can be considered “no image zones” and how they may be entered in the database is beyond the scope of the present invention. However, it is contemplated that individuals or groups might register certain geo-location area(s) as “no image zone(s)” coincident to a government-managed or privately-managed “no image zone” registry. In such manner, for example, the geo-location of certain locker rooms, corporate offices, government offices and the like may be entered in the no image zone registry and hence, the no image zone database 118.

In one embodiment, the MSC is connected by link 120 to a mobile positioning center 122. The mobile positioning center 122 is a functional element that may reside separately from or within the MSC 110. Link 120 is a logical link that may be physically realized, without limitation, by conventional subscriber lines, Asynchronous Transfer Mode (ATM) lines, ISDN lines, Ethernet LAN or WAN, wireless links, and the like. In one embodiment, the mobile positioning center 122 serves as a position determination entity (PDE) that helps determine the position of various sending devices (e.g., mobile image device 102). The position information is used by the MSC 110 to determine whether or not the sending device is within a designated “no image” zone.

As will be appreciated, any of several position determination technologies may be used to determine the position information of the sending devices. These may include, without limitation, global positioning system (GPS) or assisted-GPS (A-GPS) technologies. In the case of A-GPS, the PDE (e.g., mobile positioning center 122) shares assistance data with the mobile image device 202 to enable quicker location determination and greater sensitivity than conventional GPS; the final position calculation may be performed by the mobile positioning center 122 or the mobile image device 102. Alternatively, the mobile image device 102 may calculate its position independently using standard GPS.

In one embodiment, the position information associated with sending devices is provided in a “location-stamp” appended to image transmissions from those devices. The location-stamp is added to the header information appended to the image message, and hence received by the MSC 110 in much the same manner as a time-stamp indicating the date and time of day of the message. The location and timing information may be combined, yielding a location-time-stamp. Alternatively or additionally, the MSC 110 may query the mobile positioning center 122 or sending devices for position information rather than relying on a location-stamp.

Turning now to FIG. 2, there is shown a flowchart of a method for recognizing and blocking image transmissions from mobile image devices located in designated “no image zones.” The method is implemented, where appropriate, using stored software routines within the mobile image device 102, MSC 110 and/or mobile positioning center 122 in a communication system of the type shown in FIG. 1, wherein the “no image zone” database 118 is populated with location information associated with various designated “no image zones.

At step 202, an image is captured by the mobile image device 102 and stamped with the date, time and location of its capture. In one embodiment, the location- and/or time-stamp form a part of a header that is appended to the image file. At step 204, the message is uploaded to the wireless network, i.e., the message is sent via base station 106 to the serving MSC 110.

At step 206, the MSC 110 receives the image message and compares the location of the mobile image device (e.g., as indicated in the location-stamp) against the “no image zones” registered in the database. At step 208, the MSC 110 makes a decision whether to allow or block further transmission of the image based on the comparison against the “no image zone” registry. If the location-stamp does not match any of the designated “no-image” zones in the database 118, the MSC at step 210 allows the image file to be transmitted to the called party via the network 114. However, if the location-stamp matches any of the designated “no-image” zones, the MSC at step 212 blocks further transmission of the image file.

Optionally, if the message transmission includes information that is separable from the image file, the MSC at step 210 may permit the non-image portion of the message to be transmitted to the called party. In such manner, for example, an audio-only message or text message might be allowed to proceed to the called party without the accompanying image file. As still another option, after blocking the image transmission at step 212, the MSC may cause an announcement to be played to the calling party. For example, an announcement may be played to the effect of:
“Your image transmission has been blocked because it was sent from a location designated as a ‘no image zone.’”

As will be appreciated, the announcement may be varied as needed or desired by the service provider to accommodate different type(s) of calling parties, languages and so forth, and may be realized in different media (e.g., voice, video or text) depending on the capabilities of the sending device.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising the steps of:
receiving an image message sourced from a mobile image device;
determining a source location associated with the image message;
consulting a database to determine whether the source location coincides with a designated no-image zone; and
blocking further transmission of the image message if the source location is determined to coincide with a designated no-image zone.

2. The method of claim 1, wherein the image message includes location-stamp including indicia of the source location, the step of determining a source location comprising identifying the source location based on the location-stamp.

3. The method of claim 1, wherein the step of determining a source location comprises querying the mobile image device for the source location.

4. The method of claim 1, wherein the step of determining a source location comprises querying a position determination entity for the source location.

5. The method of claim 1, wherein the database includes location information associated with various no-image zones, the step of consulting a database comprising determining whether the source location matches the location information of any of the no-image zones.

6. The method of claim 5, wherein the location information identifies a geo-location point associated with various no-image zones, the step of consulting a database comprising determining whether the source location is within a threshold radius from the geo-location point of any of the no-image zones.

7. The method of claim 6, wherein the geo-location point specifies a latitude and longitude of the various no-image zones.

8. The method of claim 6, wherein the geo-location point specifies a latitude, longitude and elevation of the various no-image zones.

9. The method of claim 5, wherein the location information includes boundary information associated with various no-image zones, the step of consulting a database comprising determining whether the source location is within a boundary of any of the no-image zones.

10. The method of claim 9, wherein the boundary information comprises a plurality of corner point locations associated with the no-image zones.

11. The method of claim 10, wherein the corner point locations are specified by latitude and longitude.

12. The method of claim 10, wherein the corner point locations are specified by latitude, longitude and elevation.

13. The method of claim 1, wherein the step of receiving an image message comprises receiving the image message at a mobile switching center (MSC), the step of blocking further transmission of the message comprising blocking transmission of the image message from the MSC.

14. A method comprising the steps of:
receiving, at a mobile switching center (MSC), an image message sourced from a mobile image device, the image message including a location-stamp having indicia of a source location associated with the image message;
determining, by the MSC, whether the source location coincides with a designated no-image zone;
the MSC blocking further transmission of the image message if the source location is determined to coincide with a designated no-image zone; and
the MSC permitting further transmission of the image message if the source location is determined to not coincide with a designated no-image zone.

15. The method of claim 14, wherein the step of determining comprises consulting a database including location information associated with various no-image zones, the MSC making a determination based on comparing the source location associated with the image message with the location information in the database.

16. The method of claim 15, wherein the location information identifies a geo-location point associated with various no-image zones, the step of consulting a database comprising the MSC determining whether the source location is within a threshold radius from the geo-location point of any of the no-image zones.

17. The method of claim 15, wherein the location information includes boundary information associated with various no-image zones, the step of consulting a database comprising the MSC determining whether the source location is within a boundary of any of the no-image zones.
